(19) United States
(12) Patent Application Publication
(10) Pub. No.: US 2024/0423156 A1
(43) Pub. Date: Dec. 26, 2024

(54) ELASTIC TEAT CUP LINER WITH ENHANCED FUNCTIONALITY

(71) Applicant: JAKOB MAIER UND WILFRIED HATZACK ERFINDER GBR, Turkheim (DE)

(72) Inventors: Wilfried HATZACK, Turkheim (DE); Jakob MAIER, Turkheim (DE)

(21) Appl. No.: 18/566,212

(22) PCT Filed: Jun. 9, 2022
(86) PCT No.: PCT/EP2022/065736

§ 371 Date: Dec. 1, 2023

(30) Foreign Application Priority Data
Jun. 11, 2021 (DE) 10 2021 115 078.7

(51) Int. Cl. A01J 5/06

(52) U.S. Cl. CPC A01J 5/06

(57) ABSTRACT

An elastic teat cup liner (100) or teat rubber has a top region (120) which has an undulating structure that surrounds the teat insertion opening (150). As a result, the deformation behavior in the region of the teat insertion opening can be improved, so that a simpler attachment of the teat cup with higher adhesive force and less constriction can be achieved. Furthermore, the undulating structure can serve as a valve in order to reduce vacuum peaks during the milking process.

The present invention relates generally to milking technology for obtaining milk from dairy animals and relates in particular to the “interface” between animal and machine in automated or semi-automated milking in the form of a teat cup rubber or an elastic teat cup liner, which comes into contact with the teat of the animal during milking.

In today's agricultural industry, milk is usually collected from dairy animals in fully automated or semi-automated systems, which are designed in such a way that a teat cup is typically attached to each individual teat of the dairy animal in order to temporarily create a flow channel between the teat and a milk collection container. The actual contact between the animal's teat, which represents a complex and sensitive biological system for the lactating a calf, is made by a component inserted into the teat cup sleeve, which is typically referred to as a teat cup rubber or liner and hereinafter referred to as an elastic teat cup liner.

During the milking process, the elastic teat cup liner, which is made of rubber or polymer material, such as silicone, initially has the task of coming into contact with the teat of the dairy animal and adhering to the teat during the milking process through static friction and the effect of the operating vacuum prevailing under the teat and transmitted by the elastic teat cup liner.

A flow channel is created by the elastic teat cup liner adhering to the teat, via which the milk emerging from the teat is drained through the inside of the teat cup liner and ultimately fed into a pipe system and a storage container. For this purpose, the elastic teat cup liner typically has a top region that is designed to enable mechanical attachment to the teat cup sleeve and to provide a corresponding opening and contact surfaces to enable the teat to be inserted into the elastic teat cup liner. The top region is adjoined by a hose region with a certain length, which is determined by the specific application and the equipment used for mechanical milking.

When the teat of the dairy animal is sufficiently inserted into the opening in the top region of the elastic teat cup liner and the teat cup liner adheres to the teat, a part of the inner wall of the hose region also lies against the teat and thus contributes to a relatively tight contact between the teat and the teat cup liner.

In automated milking, a technique has become established whereby pressure differences are periodically generated in a spatial area of the teat cup, which is formed by the teat cup sleeve and the outer wall of the elastic teat cup liner. This causes a “folding in” of the corresponding section of the hose region at increased pressure in this space region, which is approximately equal to atmospheric pressure, whereby the flow channel in the teat and in the teat cup liner is more or less interrupted and at the same time a corresponding massaging effect on the teat is achieved by pressing the elastically deformed section of the hose region against the teat. This phase of the milking process is often referred to as the relief phase. If, on the other hand, a negative pressure is present in the region formed by the teat cup sleeve and the outer wall of the elastic teat cup liner, which, for example, corresponds approximately to the negative pressure constantly prevailing under the teat, then the corresponding portion of the hose region “unfolds” due to the inherent elasticity of the teat cup liner and releases the flow channel in and under the teat again, so that milk can escape from the teat due to the suction effect. This phase of the milking process is typically referred to as the suction phase.

The order of magnitude for the duration of a single suction phase and a subsequent release phase is in the range of 1 second, wherein the proportion of the suction phase may typically be adjusted at the expense of the release phase and a corresponding variability of the ratio of suction phase to release phase is often dynamically controlled.

At the beginning of a milking process, the teat cups must be attached to the individual teats of the dairy animal, wherein this is typically done automatically if a milking robot is used, or manually. When attaching the teat cup to a teat, the teat is inserted into the elastic teat cup liner through the opening in its top region by pushing the teat cup onto the teat essentially in the longitudinal direction of the teat, so that first the edge of the opening comes into contact with the teat and is deformed in the process and finally contact is made with the inner wall of the hose region, thereby ensuring more or less tight contact between the inner wall of the corresponding portion of the hose region and the teat. This tight sealing of the contact surfaces between the teat and the teat cup liner leads to the teat cup sticking due to the “milking vacuum” prevailing in the inner area of the elastic teat cup liner or the corresponding negative pressure in conjunction with the static friction of the surfaces of the teat cup liner in contact with the teat. The length of the section of the teat with which the teat ultimately penetrates the elastic teat cup liner depends on the diameter of the opening and the anatomical conditions of the teat in question.

It should be noted that the teat typically changes during the milking process, so that different anatomical conditions for contact between teat cup and teat exist depending on the phase of the milking process.

For example, during the milking process in an advanced phase, the teat may become somewhat “slack”, so that a larger portion of the teat is “sucked” into the teat cup liner due to the constant negative pressure under the teat, which is manifested by the teat cup “climbing” up the teat. However, this altered position of the teat cup may lead to the pressurization of vessels in the upper area of the teat and near the bottom of the udder, thereby potentially causing a detrimental effect on the animal and thus possibly resulting in increased restlessness and con-sequently the risk of premature termination of the milking process and thus incomplete milking.

In this respect, the publication DE 1 782 263 describes a teat cup liner, in which corresponding projections in the form of elevations are provided at the edge of the opening, which act more strongly on the teat wall in the clamped state, deform it accordingly and thus establish increased contact with the teat, so that the “lowering” of the teat or the “climbing up” of the teat cup during each suction/relief cycle is to be prevented.

The publication U.S. Pat. No. 1,260,466 A describes a teat cup liner which, by providing elastic elements on a ring above the opening of the teat cup liner, creates an intimate contact with the teat wall by deformation when the teat is inserted, so that the teat cup is held in the desired position by the elastic deformation of the elements downwards and outwards. On the other hand, the adhesion of the elastic elements to the teat can be eliminated or at least significantly reduced if the teat cup is rotated so that the teat cup can be easily removed from the teat manually in this rotated state.

Furthermore, during certain phases of the milking process, a negative pressure may be created directly under the teat that exceeds the originally applied operating negative pressure, for example when milk that is milked during the suction phase is quickly removed, so that a negative pressure peak is created between the teat and the milk portion moving away.

In this respect, it should be noted that, in the context of this application, an “increase” in the value of the negative pressure is to be understood as meaning that the pressure difference between the pressure under the teat and a reference pressure, for example the ambient atmospheric pressure, increases. A higher value of the negative pressure, such as a “negative pressure peak”, therefore indicates that the pressure is lower in absolute terms and thus the difference to the reference pressure is greater.

In this context, the publication U.S. Pat. No. 2,340,295 describes a teat cup liner that has a surface structure on an uppermost, almost horizontal surface of its head, for example in the form of small radial channels or ribs. This structured surface is intended to form a relatively tight seal in conjunction with the surface of the bottom of the udder, although at the end of the suction phase the structure is intended to create small air inlet channels so that a small amount of air can penetrate along the bottom of the udder to the teats, thereby reducing the negative pressure under the teat in order to achieve an improved overall milking adapted to the natural suckling of the calf.

The publication U.S. Pat. No. 3,308,788 describes a system consisting of a teat cup with insert and a separate plate, the plate having an opening whose diameter is smaller than the diameter of the opening of the teat cup liner. The plate is placed on the teat cup liner or fitted accordingly and contains elastic elements that make good mechanical contact with the teat and at the same time allow a small amount of outside air to enter along the teat walls. This is intended to increase adhesion when the negative pressure under the teat is reduced by the amount of air introduced. In this way, the teat is to be sealed after the respective udder cistern has been emptied, preventing contaminated air and milk from entering the udder cistern. The ring can be designed in such a way that it can also be used in conjunction with conventional teat cup liners.

There are different diameters for the openings of the elastic teat cup liners in order to take account of anatomically different conditions, such as length, diameter and the like of the teat of the dairy animal. In practical operation, however, it is virtually unavoidable that a special teat cup liner has to be used for many different sized teats of the dairy animals. It is therefore of great importance to design the top region in particular in the vicinity of the opening for inserting the teats in conjunction with the adjacent hose region so as to allow rapid attachment, in automated or manual manner, wherein reliable attachment should already be achieved on the first attachment attempt. Furthermore, the contact between teat cup and teat should be maintained as reliably as possible during milking in order to prevent the teat cup from falling off prematurely with the associated disadvantages.

Great efforts have therefore been and are being made to realize an efficient milking process, wherein solutions are proposed in particular for the aforementioned problem of negative pressure peaks, according to which, for example, atmospheric air is introduced in doses at certain phases or continuously through appropriately designed valve elements or nozzle elements in the top region of the teat liner and/or directly under the teat in order to at least reduce corresponding negative pressure peaks. The aforementioned publications also describe solutions, in which small amounts of air are regularly introduced. Typically, these measures, if they are accompanied by additional valves or plate arrangements, are associated with costly technical modifications, which therefore contribute to greater complexity and thus greater susceptibility to faults, as well as greater effort in cleaning and maintenance or may cause adverse effects if these devices fail.

In view of the above, it is an object of the present invention to provide means, according to which one or more of the above problems may be avoided or at least reduced in their effect.

The aforementioned object is addressed according to the invention by an elastic teat cup liner that serves to receive a teat. The elastic teat cup liner has a hose region, a top region that is adjacent in the longitudinal direction of the hose region, is designed for attachment to a teat cup sleeve and is provided with a teat insertion opening, and an annular region that delimits the teat insertion opening, acts as a teat contact surface in the operating position and has a undulating structure along the circumference of the teat insertion opening with an underside facing the hose region and an upper side facing away from the hose region. The hose region, the top region and the annular region including the undulating structure are formed as a single piece of material. A wave crest of the undulating structure contains a wave crest portion in the circumferential direction of the teat insertion opening, at which the underside of the wave crest portion has a maximum distance from the hose region, and a wave trough of the undulating structure contains a wave trough portion, at which the underside of the wave trough portion has a minimum distance from the hose region that is different from the maximum distance.

The teat cup liner according to the invention thus has, in particular, the undulating structure that imparts to the teat insertion opening a higher degree of adaptability to a teat to be inserted. This improved adaptability, i.e. deformability, causes the teat cup liner to adhere more inten-sively to the teat immediately when the teat cup is attached to the teat, as well as during the entire milking process, without, however, having any biologically detrimental effects.

In particular, the teat cup liner according to the invention enables milking of a larger proportion of dairy animals in a herd with a given diameter of the teat insertion opening, since a selected diameter of the teat insertion opening of the teat cup liner according to the invention ensures more reliable and animal-friendly milking for a larger range of different teat sizes compared to conventionally designed teat cup liners. The undulating structure, which forms the edge of the teat insertion opening and runs radially outwards from there, has the function of a “bellows” that may change its “length” and thus also the diameter of the teat insertion opening. This means that when the teat insertion opening is pushed onto a teat, the undulating structure expands more or less in the circumferential direction of the opening depending on the teat diameter. The wave crests mainly coming into contact with the teat wall while deforming the annular region downwards and outwards always ensure sufficient adhesion to the teat. Due to the bellows-like structure described above, the suitable position of the teat cup liner for teats with a smaller diameter and also for teats with a larger diameter will therefore be in the central area of the teat in the longitudinal direction, without causing the risk of the teat cup falling off.

Typically, it is correspondingly complex to meet the different requirements of a herd of dairy animals on a daily basis. For example, if there are animals with relatively small teats in the herd to be milked, one or more milking parlors may have to be reserved for these animals in order to provide milking clusters with suitable teat cup liner diameters. In practice, this is relatively time-consuming, especially if this type of “selection” is to be carried out on small or me-dium-sized farms. But even on large farms, selecting the dairy animals in terms of teat size and providing appropriate milking parlors with teat cup liners with different diameters of teat insertion openings requires a great deal of effort. Therefore, especially on small and medium-sized farms, the milking process is often carried out with a “compromise” liner, wherein the diameter of the liner openings is selected so that the majority of the dairy animals in the herd may be milked relatively efficiently. However, for dairy animals with larger teats, i.e. teats that are too large for the selected opening diameter, this procedure may typically lead to congestion in the teat vessels, which may have corresponding detrimental effects on the teat and thus on yield, both in the short and long term. On the other hand, in animals with teats that are too small compared to the “compromise” liner, there is little adhesion, which means that there is a risk of the teat cup falling off during the milking process, thus interrupting the milking process.

This leads to additional work due to the need to reattach the teat cups and typically prolongs the milking process. A drop-off of a teat cup may also result in incomplete milking out of one or more udder quarter(s)/half(s). However, as explained above, the teat cup liner according to the invention enables minimizing the effort required to adjust the teat liner selection and possible impairments due to non-optimal adjustment of teat to opening diameter due to the significantly larger range of teats that may be milked in a reliable and animal-friendly manner by a single selected opening size due to the undulating structure. In other words, the teat cup liner according to the invention is more tolerant with regard to teat size fluctuations compared to conventionally designed liners.

It should be noted that a undulating structure within the meaning of the present application is to be understood as a structure in which, along a circumferential direction of the teat insertion opening, alternating elevations, i.e., material sections with an upper side and a lower side, and depressions, i.e., material sections with an upper side and a lower side, occur, which are designated accordingly as wave crests and wave troughs. A wave crest is to be understood as an “elevation” in the sense that in the longitudinal direction of the teat cup liner, for example in relation to an imaginary central axis of the teat cup liner, the top region lies “above” and the hose region lies longitudinally behind the top region and thus “below” the top region. A wave crest is thus a section in the circumferential direction of the teat insertion opening that contains a wave crest section, at which the underside, i.e. the side of the section facing the hose region, has a maximum distance from the hose region, and a wave trough is a section in the circumferential direction of the teat insertion opening that contains a wave trough section, at which the underside has a minimum distance from the hose region, the minimum distance being smaller than the maximum distance. In other words, in a side view, the wave crest and wave trough are to be understood as a “serpentine” arrangement that thus forms a bellows-like structure for elastically extending the circumference of the opening, wherein in a resting state, i.e. without an inserted teat, the “serpentine” of the undulating structure, i.e. the extension in the circumferential direction of the opening, has its minimum length or extension. The wave crests and wave troughs are therefore “deflected” in the longitudinal direction in relation to each other.

Furthermore, a undulating structure as used herein is to be understood as a structure, in which the wave crests and/or the wave troughs in the previously described side view, i.e. the “serpentine line or bellows shape” in a view perpendicular to the longitudinal direction, may have any shape, for example in the form of circular arcs, a combination of circular arcs with different radii, possibly in conjunction with straight sections, and the like. For example, the crests and/or troughs of the waves are designed as rounded shapes, squares, rectangles, triangles or the like when viewed from the side. The resulting line shape is therefore also referred to as serpentine. In preferred embodiments, the side view shapes of the wave crests and wave troughs are rounded so that there are no pronounced edges.

Upon attaching the teat cup to the teat of the dairy animal, for example, the undulating structure results in a deformability that requires less force, particularly in the annular region, in which the undulating structure is formed adjacent to the teat insertion opening, so that the teat may enter the opening relatively unhindered. At the same time, it may come into contact with the corresponding wave crests, so that once the teat has reached a certain penetration depth, a stable mechanical contact is created between the teat cup liner and the teat in its upper area and thus, also in cooperation with the adjacent wall area of the hose region, a virtually airtight seal is made possible, wherein the teat cup reliably attaches itself to the teat and thus adheres. In other words, this increased flexibility in the deformation of the annular region at the edge of the teat insertion opening reduces the mechanical force exerted on the teat and thus generally reduces the force required to insert the teat into the teat insertion opening, while at the same time ensuring more intensive contact between the teat and teat cup liner. The result thereof is improved conditions for both the operator or the milking robot and the animal when attaching the teat cup compared to conventional teat cup liners, as the stress on the teat is reduced. In particular, when the teat cup liner according to the invention is used in conjunction with a milking robot, the number of attachment attempts required for ultimately successful attachment is reduced, as is the number of failed attachments. This increases the throughput of the milking robot, i.e. the number of milkings per time unit, and the reliability of the milking robot may also be increased, as the number of manual interventions may be reduced due to the lower number of unsuccessful attachments and thus the reduced number of failed milkings.

Also in the further course of the milking process, in which negative pressure peaks may occur, as explained at the beginning, the enhances flexibility or the more efficient deformability of the annular region of the undulating structure in the vicinity of the teat insertion opening also has a beneficial effect, since under these conditions, due to the presence of the wave troughs, a slight controlled detachment occurs, caused by the inherent elasticity of the material of the undulating structure, so that a brief gas exchange takes place between the interior of the teat cup liner and the surrounding atmosphere and this may contribute to a reduction in possible negative pressure peaks. In other words, this results in the effect of a valve that opens one or more flow channels between the interior and the surrounding atmosphere in a self-controlling manner when negative pressure peaks occur, in order to enable the negative pressure peaks to be reduced without, however, reducing the negative pressure to a value that would cause the teat cup to fall off. In this way, on the one hand, reliable attachment of the teat cup is ensured even during critical phases of the milking process, while on the other hand, unfavora-ble pressure conditions at the teat are avoided or significantly reduced, so that corresponding adverse effects on the physiology of the teat are avoided or at least reduced. For example, this also significantly reduces the climbing up of the teat cup, since if the anatomy of the teat changes during the milking process, as explained above, at least an increase in the negative pressure may essentially be avoided.

The “one-piece” design, in which the top region, the hose region and the annular region with the undulating structure are formed as a single piece of material, has the advantage of cost-effective production, in which the structural characteristics, in particular of the undulating structure, are defined with high precision by design measures, by the shape of the mold. Furthermore, the one-piece design has advantages when handling the teat cup liner, for example when attaching it to the teat cup sleeve, as well as in practical use, for example when regularly cleaning the teat cup, as there are no unnecessary joints where deposits may accumulate.

In a further advantageous embodiment, a radial extension of the undulating structure in the annular region starting from the edge of the teat insertion opening is numerically greater than a radius of the teat insertion opening. In other words, starting from the edge of the teat insertion opening, the undulating structure extends in a radial direction, i.e. in the direction that is perpendicular to the circumferential direction and thus perpendicular to the “propagation direction” of the wave, up to a distance that is numerically greater than the amount of the radius of the teat insertion opening. This ensures to an even greater extent that the increased flexibility provided by the undulating structure is also given when inserting teats with different teat diameters. This is due to the fact that if the annular region is lowered accordingly when the teat is inserted, the effect of the undulating structure is effective over a long distance radially outwards, towards the edge of the top region. If the radius of the teat insertion opening is scaled accordingly, for example if teat cup liners with very different teat diameters and/or for different animal species are specified, a high degree of flexibility in the area of the opening is thus always ensured and the effect is further improved, according to which a larger range of teat diameters may be covered, as also explained above.

In a further advantageous embodiment, the wave crest section and the wave trough section have different wall thicknesses. This measure enables adjustment of the flexibility, which is already more pronounced due to the undulating structure, and thus the deformability in a controlled manner by means of design measures, i.e. by designing an injection mold accordingly. In other words, the wall thickness of the wave crest section or the wave trough section is determined during the production process of the teat cup liner in such a way that the desired controlled deformability is achieved. This controlled deformability may be produced to a high degree over many products with consistent quality, as the wall thickness is determined during the production process, for example during injection molding, and only very small or even min-imal and well-known tolerances may occur.

In a further advantageous embodiment, the wave crest section has a greater wall thickness than the wave trough section. This design measure ensures that the deformability and thus flexibility of the undulating structure along the longitudinal axis of the elastic teat cup liner is adjusted in such a way that the teat cup may be pushed onto the teat with less resistance, while in the opposite direction the modified flexibility increases the resistance, so that adhesion after attachment is significantly improved.

In a further advantageous embodiment, an extension length of the wave troughs at the edge of the teat insertion opening is greater than an extension length of the wave crests. I.e., directly at the edge of the teat insertion opening, i.e. in a side view of the teat insertion opening, approximately as viewed from the teat insertion opening, the undulating structure is designed such that the wave crests have a smaller length and are therefore more curved, i.e. have a smaller radius of curvature. In other words, the extension of the crests along the circumferential direction of the teat insertion opening is smaller than the corresponding extension of the troughs, which have a larger radius of curvature and therefore a smaller curvature. It should be noted that the radius of curvature may change along a wave crest or wave trough, for example if relatively straight sections are provided, and in this context the radius of curvature is to be understood as an averaged radius of curvature for a wave crest or wave trough. The transition between a wave trough and a wave crest may be understood as the inflection point of an imaginary line in the center of the material of the undulating structure.

This design means that the crests of the waves directly at the teat insertion opening are relatively compact in their circumferential extension and thus leave room for significantly more pronounced wave troughs, which therefore ensure improved deformability directly at the teat insertion opening.

In a further advantageous embodiment, the extent of the wave troughs in the circumferential direction remains essentially constant with increasing distance from the teat insertion opening. In other words, as the radial distance from the teat insertion opening increases, the extent of the wave troughs in the circumferential direction does not change significantly, i.e. is essentially constant, so that the extent of the wave crests in the circumferential direction increases accordingly. This ensures that, on the one hand, the required deformability of the annular region is maintained even at a greater radial distance from the teat insertion opening, while, on the other hand, the circumferential extension of the wave crests increases, so that the size of the effective contact surface with the teat also increases as the radial distance from the teat insertion opening increases. This ensures that even with smaller diameter teats, where the teat must be inserted farther into the teat insertion opening, increasingly better adhesion is achieved in the upper area of the teat, thereby ensuring that adhesion already occurs before the top region is in contact with the base of the teat, i.e. directly with the bottom of the udder.

In a further advantageous embodiment, at least three wave troughs are provided in the undulating structure. This minimum number of wave troughs and thus also of wave crests results in sufficient deformability, which leads to the advantageous effects already described. In other embodiments, six or more wave troughs are provided. In this way, the effectiveness of the undulating structure may be further improved, as a “finer” structuring is obtained, which may thus be adapted more efficiently to different teat sizes, i.e. different lengths and diameters of the teats.

In advantageous embodiments, the annular region is inclined from the edge of the top region towards the teat insertion opening in the direction of the hose region. In other words, the teat insertion opening is set back “downwards” in relation to an uppermost surface of the top region, i.e. set back in the direction of the hose region, which results in an already structurally better deformability of the annular region during attachment, which further reinforces the effect of the undulating structure in this respect.

In other embodiments, a corresponding inclination of the annular region and thus lowering of the teat insertion opening is not provided, as the undulating structure itself already ensures the necessary adaptability of the teat insertion opening in the manner described above.

In advantageous embodiments, the teat insertion opening is suitably dimensioned so that a teat of a large dairy animal, in particular a cow or a buffalo, may be inserted therein.

In other embodiments, the teat insertion opening is suitably dimensioned such that a teat of a small dairy animal, in particular a sheep or a goat, may be inserted therein.

In this way, the elastic teat cup liner may be used on a large number of teats with different anatomies.

The aspects and embodiments of the invention described above, as well as further embodiments, are now described in more detail with reference to the accompanying drawings, in which:

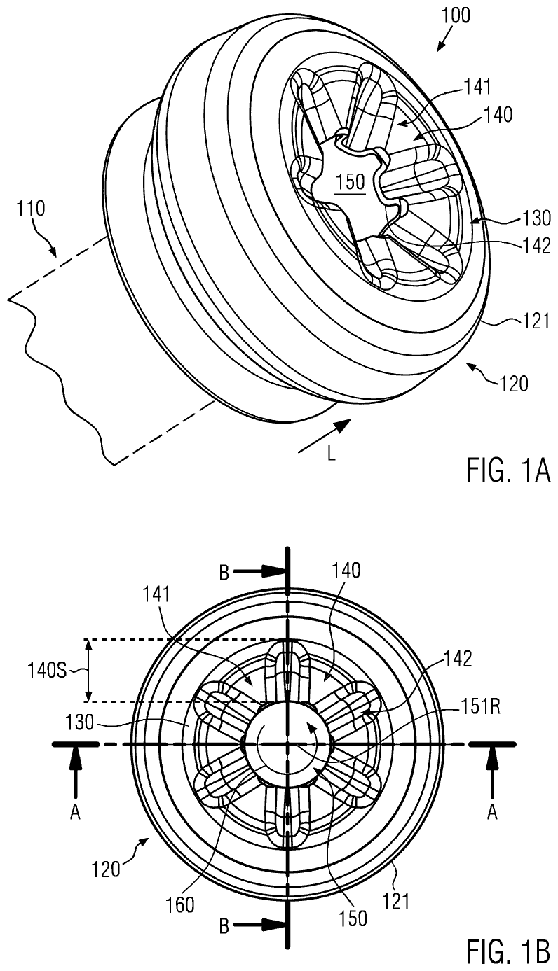

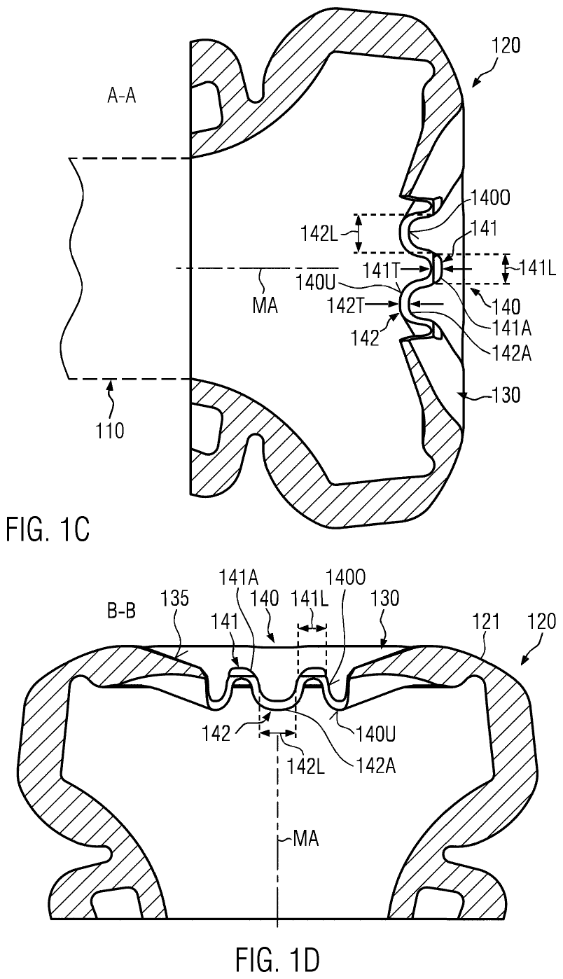

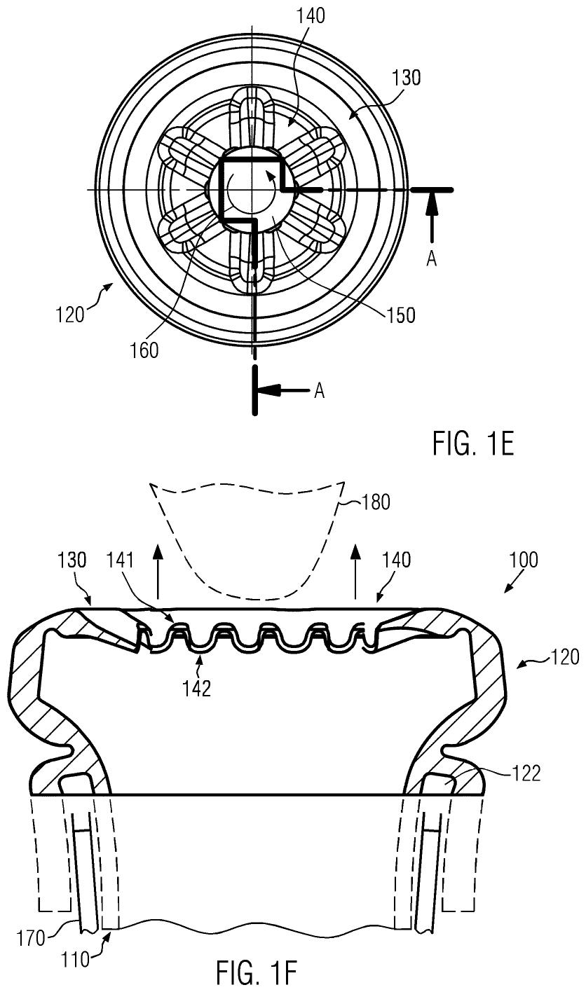

FIG. 1A schematically shows a perspective view of a part of a teat cup liner, which has a top region with an undulating structure,

FIG. 1B shows a plan view of the top region from “above”,

FIG. 1C shows a sectional view through the part of the teat cup liner corresponding to the section A-A shown in FIG. 1B,

FIG. 1D shows a sectional view of the top region corresponding to section B-B of FIG. 1B,

FIG. 1E shows a top view of the top region with a section line drawn in, which covers approximately ¾ of the circumference of the teat insertion opening,

FIG. 1F shows a sectional view of the teat cup liner along the sectional line A-A shown in FIG. 1E,

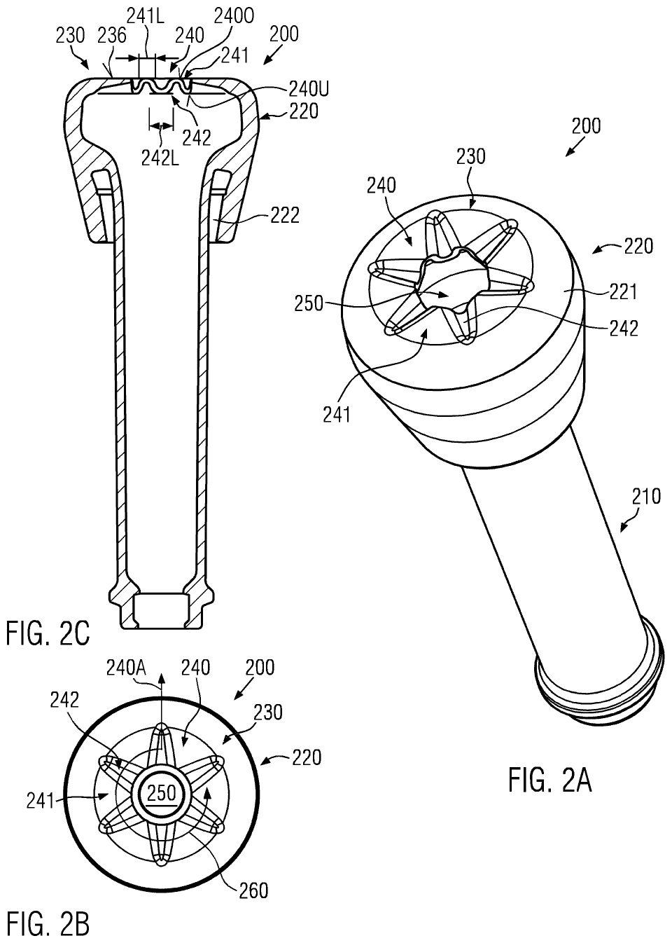

FIG. 2A schematically shows a perspective view of another teat cup liner,

FIG. 2B shows a top view of the teat cup liner of FIG. 2A and

FIG. 2C shows a sectional view of the teat cup liner of FIGS. 2A and 2B.

FIG. 1A shows a schematic perspective view of a part of a teat rubber or an elastic teat cup liner 100, which is uniformly and as a single piece of material made of an elastic material, such as rubber, a polymer material, in particular a silicone material, and the like. The elastic teat cup liner 100 has a hose region 110, which is merely schematically indicated, and a top region 120. The hose region 110 and the top region 120 are arranged one after the other in a longitudinal direction L, wherein in the present application the top region 120 is located “at the top” with respect to the hose region 110.

The top region 120 is generally configured to enable a mechanical connection with a teat cup sleeve (not shown), as described in more detail in connection with FIG. 1C. Furthermore, the top region 120 has an edge 121 which, depending on special circumstances, is more or less bulged compared to a lower part of the top region 120 or compared to the hose region 110. Furthermore, an annular region 130, hereinafter simply referred to as the annular region, is provided, in the center of which a teat insertion opening 150 is formed. Furthermore, an undulating structure 140 is formed in the annular region 130 in such a way that the teat insertion opening 150 is thus delimited by a circumferential undulating contour, i.e. the undulating structure 140. That is, the undulating structure has a “wave propagation direction” in the form of a serpentine line that extends in the circumferential direction of the opening 150. Wave crests 141 and wave troughs 142 are therefore arranged alternately in the circumferential direction.

The size of the teat insertion opening 150 in the resting state, i.e. without an inserted teat, for example its diameter, is adapted to the anatomical conditions of a teat of a dairy animal to be milked. For example, the elastic teat cup liner 100 may be suitably dimensioned for milking relatively small dairy animals, such as sheep, goats and the like. In this respect, the dimensions, such as the length and, in particular, the diameter of the elastic teat cup liner 100 and thus also of the teat insertion opening 150 formed therein must be determined accordingly. When designed for the milking of larger dairy animals, such as cows, buffaloes and the like, which generally have somewhat larger teats, the dimensions of the elastic teat cup liner 100 have to be adapted accordingly. Corresponding basic dimensions for different dairy animals, as well as different anatomical features of dairy animals of the same breed, are well known and may be applied accordingly to the present elastic teat cup liner 100.

FIG. 1B schematically shows a top view of the top region 120 of the elastic teat cup liner 100 shown in FIG. 1A, wherein the teat insertion opening 150 is shown as a centrally located circular opening, the radius 151R of which is to be adapted to the respective circumstances, as previously explained. A central circular opening is commonly used so that the corresponding teat cup liners may be used without regard to their subsequent position in the milking cluster. Within the scope of the present invention, it is also possible to select the general shape of the teat insertion opening 150 so as to deviate from the circular shape. For example, the circumference of the teat insertion opening 150 in plan view may have the shape of a polygon, an oval, and the like. If an oval shape is selected, the appropriate suitable angular position may have to be taken into account when installing the teat cup liner 100 in a corresponding teat cup sleeve.

Furthermore, in the embodiment shown, the radial extent of the undulating structure 140, i.e., the combination of the wave crests 141 and the wave troughs 142, is determined such that the numerical amount of the radial extension, which is shown here as 140S by way of example, is greater than the numerical amount of the radius 151R of the teat insertion opening 150. As already explained above, a corresponding dimensioning of the radial extension 140S of the undulating structure 140 is advantageous, since the deformability of the annular region 130 is thus very pronounced when a teat is inserted into the opening 150 and reliable contact of the wave crests 141 with the respective teat section is thus possible. In other embodiments (not shown), the radial extension 140S is numerically smaller than the radius 151R of the opening 150 if a “harder” or “more rigid” behavior of the teat cup liner 100 in the region of the opening 150 is desired.

Furthermore, in the embodiment shown, the extension of the wave troughs 142 along the circumferential direction, which is designated here as 160, is designed in such a way that it is almost constant even at a greater radial distance from the teat insertion opening 150. That is, the dimension of the wave troughs remains the same with increasing radial distance from the opening 150, so that accordingly the wave crests 141 have an almost triangular shape in plan view, wherein a corresponding contact surface provided by the upper side of the wave crests 141 becomes larger with increasing radial distance. In this way, with increasing penetration of a teat into the opening 150 and the associated deformation and downward folding of the annular region 130, an ever-increasing contact surface is created with simultaneously good deformability of the annular region 130.

FIG. 1C shows a schematic cross-sectional view along the sectional line A-A shown in FIG. 1B.

As is evident from this view, the deflections of the wave crests 141 and wave troughs 142 run along the longitudinal direction L (see FIG. 1), or also in the direction of a central axis MA. The wave crests 141 and the wave troughs 142 thus form a “serpentine line” with a lower side 140U facing the hose region 110 and an upper side 1400 facing away from the hose region 110. Thus, each wave crest 141 has a wave crest section 141A, at which the lower side 140U of the wave crest section 141A has a maximum axial distance from the hose region 110. In the same way, each wave trough 142 has a wave trough section 142A, at which the underside 140U of the wave trough section 142A has a minimum axial distance from the hose region 110. The minimum distance is less than the maximum distance, i.e. both the lower side 140U and the upper side 1400 run as serpentine lines in the circumferential direction. As already explained above, the geometric shape of the crests 141 and troughs 142 in the side view is not restricted in any particular way, provided that raised areas appear as crests 141 and de-pressed areas as troughs 142 and the lower side 140U and the upper side 140A appear as serpentine lines. In embodiments not shown, the crests 141 and/or the troughs 142 may have more or less pronounced edges, provided that this is feasible during manufacture and is con-sidered suitable for the application.

Furthermore, in the embodiment shown, an extension 142L in the circumferential direction of the wave troughs 142 is greater than a corresponding extension 141L in the circumferential direction of the wave crests 141, this being true for the edge region bounding the teat insertion opening 150, as shown in FIG. 2 and FIG. 1. With increasing radial distance from the opening 150 (see FIG. 1 or FIG. 2), the extension 142L in the circumferential direction of the wave troughs 142 remains essentially the same, while the radial extension 141L in the circumferential direction of the wave crests 141 increases steadily.

For the embodiment shown, it therefore applies to the edge of the teat insertion opening 150 that a radius of curvature of the crests 141 is relatively small there corresponding to the small extension length 141L in the circumferential direction, while a radius of curvature for the troughs 142 is relatively large, so that the larger extension in the circumferential direction 142L is thus obtained. That is, at the edge of the teat insertion opening 150, the radius of curvature of the wave crests 141 is less than the radius of curvature of the wave troughs 142. It should be noted that a corresponding radius of curvature is to be understood as an average value for a section of the corresponding wave crest or wave trough. That is, for the corresponding extension 142L of the wave troughs 142, a mean radius of curvature is greater than a mean radius of curvature that results for the extension length 141L of the wave crests 141.

As previously explained in connection with the plan view of FIG. 1B, a corresponding radius of curvature for the wave troughs 142 remains substantially the same with increasing radial distance from the opening 150, while the corresponding radius of curvature for the wave crests increases with increasing radial distance from the opening 150 and may become greater than the radius of curvature of the wave troughs at the radial distance from the opening 150 under consideration.

In other embodiments not shown, an increase or decrease in the extension in the circumferential direction of the wave troughs 142L may be provided, wherein the deformation behavior in particular may be adjusted by design measures. Accordingly, the corresponding extension length 141L of the wave crests changes in a complementary manner.

In the embodiment shown in FIG. 1C, a wall thickness 141T, at least in the region of the maximum of the respective wave crests 141, i.e. in the wave crest section 141A, is greater than a wall thickness 142T of the wave troughs 142, at least in their minimum, i.e. in the wave trough section 142A.

As already explained above, the adjustment of the wall thicknesses 141T, 142T enables controlling the deformation behavior of the undulating structure 140, since, for example, if the wall thickness 141T is increased further, the undulating structure 140 becomes “harder” on contact with the surface of the teat. The wall thickness 141T may also be used to adjust the stiffness of the undulating structure 140. On the other hand, for the wall thickness 142T of the wave troughs 142 the fact holds true that a reduction in this respect increases the overall deformability of the undulating structure 140, wherein the diameter of the teat insertion opening 150 increases more efficiently when inserting a teat.

FIG. 1D schematically shows a sectional view of the top region 120 corresponding to the sectional line B-B of FIG. 1B. That is, in contrast to the view of FIG. 1C, in which a wave crest 141 is centrally located with respect to the center axis MA, in the view of FIG. 1D a wave trough 142 is centrally located with respect to the center axis MA.

Furthermore, as is evident form FIG. 1D (and also FIG. 1C, as well as FIG. 1A), in the embodiments shown, the annular region 130 is provided with an inclination 135 such that the opening 150 (see FIG. 1B), and thus the corresponding edge region of the undulating structure 140, is lowered compared to the edge 121 of the top region 120. This recessed arrangement of the opening 150 results in a more favorable behavior during deformation when a teat is inserted into the opening 150, so that in addition to the increased flexibility and deformability created by the undulating structure 140, a further contribution is made, wherein the process of inserting the teat, i.e. attaching the teat cup, becomes more efficient, while making it more difficult for the teat to move out, so that overall the adhesion of the teat cup to the teat during the milking process is increased.

FIG. 1E shows a further top view of the top region 120, wherein a section line A-A is shown which sweeps over approximately three-quarters of the circumference 160 of the teat insertion opening 150.

FIG. 1F shows the corresponding sectional view along the sectional line A-A of FIG. 1E, wherein four complete wave troughs 142 of the six wave troughs 142 provided in this embodiment are visible. Similarly, four complete wave crests 141 of the six wave crests 141 are visible. The number of wave crests and thus wave troughs 141, 142 may also be determined during the manufacture of the teat cup liner 100 to adjust the deformation behavior. In illustra-tive embodiments, at least three wave crests and wave troughs are provided, while in other embodiments, such as the one shown, at least six wave crests and wave troughs are provided. A corresponding limitation of the number of wave crests and wave troughs results, for example, from manufacturing conditions, such as when the radius of curvature of the wave crests or wave troughs at a given radial position becomes so small with a high number of wave crests and wave troughs that correct shaping is no longer guaranteed during the corresponding injection molding process. For example, if the radius of curvature is too small, it may no longer be possible to set the desired wall thickness with the desired precision. However, with typical dimensions for elastic teat cup liners for goats, sheep, cattle and the like, the number of wave crests and wave troughs may be increased to 8-10 without difficulty.

Furthermore, FIG. 1F shows a corresponding incision 122 which serves to receive the wall of a teat cup sleeve 170, so that a mechanical fixation to the teat cup sleeve 170 and a tight seal to it are achieved.

During use of the elastic teat cup liner 100, which is attached to the teat cup sleeve 170 for this purpose and thus forms a teat cup, which in turn is part of a corresponding set of teat cups, the teat cup and thus the teat cup liner 100 is brought up to a teat 180, so that ultimately the teat 180 enters the opening 150. As a result, the annular region 130 including the undulating structure 140 is deformed accordingly, i.e., pressed “down” in the longitudinal direction, so that the wave crests 141 come into contact with the outer surface of the teat 180. In other words, due to the elastic deformation of the undulating structure 140 upon inserting the teat 180 the efficient deformability of the undulating structure 140 leads to insertion with only a small amount of force, until finally the elastic restoring force of the undulating structure 140 leads to adhesive contact with the teat 180, so that reliable adhesion of the teat cup liner 100 and thus of the respective teat cup is ensured. In other words, in this position, which is also referred to as the operating position, in which the undulating structure 140 is deformed “downwards” (not shown), a relatively high adhesive force is effective which, in conjunction with a contact region (not shown) of the hose region 110, results in undesired premature detachment of the teat cup from the teat 180 being substantially avoided without the teat being pinched off. As a result, the attachment process is simplified and the general adhesion of the teat cup during the milking process is higher, wherein, as already mentioned, a negative influence, for example by constriction, is virtually avoided, as is otherwise the case with conventional liners with a suitable or relatively narrow diameter.

If certain negative pressure peaks occur under the teat during milking, as already explained above, then the undulating structure 140 enables a slight detachment from the teat 180 in certain areas, but without reducing the adhesion to the teat 180 in such a way that a cup drop occurs. One or more flow channels are temporarily created between the interior of the teat cup liner 100 and the surrounding atmosphere by this partial detachment. This valve effect may therefore significantly reduce vacuum peaks, so that a reliable and animal-friendly milking process may be carried out. A high head vacuum may lead to a swelling of the teat so that the teat acts almost like a plug, making further milking of the relevant udder area more difficult, which may lead to udder health problems. For example, this may lead to an increased proportion of residual milk in the affected udder area, which in turn may lead to an impairment of udder health and/or a loss of yield.

FIG. 2A shows a perspective view of a teat cup liner 200 according to further embodiments of the present invention. The teat cup liner 200 has, in a similar manner to the teat cup liner 100 described above, a hose region 210 and a top region 220 adjacent thereto in the longitudinal direction of the hose region 210. The top region 220 has an edge 221 and is further configured to be attached to a teat cup sleeve (not shown), as also previously explained in connection with FIGS. 1A-1F. Furthermore, an annular region 230 is provided in the top region 220, which in turn includes a undulating structure 240 with wave crests 241 and wave troughs 242. With regard to the terms undulating structure, wave crests and wave troughs, reference is made to the preceding explanations. The annular region 230 in conjunction with the undulating structure 240 defines a teat insertion opening 250, which serves to receive a teat.

In the embodiment shown, the undulating structure 240 is designed such that the wave troughs 242 have a smaller extent in the circumferential direction with increasing radial distance from the opening 250. In other words, in contrast to the undulating structure 140 of the preceding embodiments, the wave troughs 242 become smaller in their circumferential extent towards the outside and thus result in the wave crests 241 increasing more strongly in the circumferential direction with increasing radial distance than is the case for the design of the undulating structures 140 of the previously described embodiments. The degree of “tapering” of the wave troughs 242 with increasing radial distance from the opening 250 may be determined by design during manufacture as required, for example in order to increase the rigidity of the undulating structure 240 and thus of the annular region 230 with increasing radial distance. In this way, a higher degree of holding force may be achieved with smaller teats or when using a softer polymer mixture of the teat cup liner if, for example, the teat diameter under consideration would be too small for the diameter of the opening 250 of a conventional teat cup liner. However, due to the undulating structure 240, the opening 250 is nevertheless suitable for the teat in question in this case, since a reliable hold is obtained even for the relatively small teat if the teat cup liner is pushed on accordingly.

FIG. 2B shows a top view of the teat cup liner 200, wherein it may be seen more clearly here that the undulating structure 240 with the wave crests 241 and the wave troughs 242 is designed such that the corresponding extension or length of the wave crests 241 and the wave troughs 242 along a circumferential direction 260 of the opening 250 changes with increasing radial distance 240A from the opening 250. In the embodiment shown, this means that the extension in the circumferential direction of the wave troughs 242 becomes less as the distance 240A increases. Starting from the opening 250 and pointing outwards, the corresponding extension in the circumferential direction is thus reduced, while on the other hand the extension in the circumferential direction of the wave crests 241 accordingly becomes larger, thereby increasing “faster” than is the case for the embodiments described above, in which, for example, the extension in the circumferential direction of the wave troughs remains approximately the same with increasing radial spacing. By adjusting the degree of tapering of the wave troughs 242 with otherwise constant parameters, such as material thickness, material type and the like, the size of the contact surface on the one hand and also the resilience of the undulating structure 240 on the other hand may thus be determined by design as a function of the radial distance 240A.

FIG. 2C schematically shows a sectional view of the teat cup liner 200. As shown, the top region 220 is provided with a receptacle 222 that is suitably configured to embrace an upper portion of a teat cup sleeve (not shown) so that a reliable mechanical connection between the teat cup sleeve and the teat cup liner 200 is ensured. As further shown, the annular region 230 with the undulating structure 240 is configured such that the maxima of the wave crests 241 are nearly planar to an unstructured surface 236 of the annular region 230. That is, in this embodiment, there is no “dip” of the undulating structure 240 that would be caused by an inwardly directed slope, such as is the case with the slope 135 of the annular region 130 in some previously described embodiments (see FIG. 1D).

As further shown, at the edge region of the opening 250 (see FIG. 2B), an extension 242L of the wave troughs 242 in the circumferential direction 260 (see FIG. 2B) is greater than a corresponding extension 241L of the wave crests 241, this relationship changing rapidly and reversing with increasing radial distance from the opening 250, as previously explained. Further, the wall thicknesses of the crests 241, such as in a crest section 241A, and the troughs 242, such as in a trough section 242A, may be the same or different. As previously explained in connection with FIGS. 1A-1F, in some embodiments it is advantageous to select the wall thickness of the wave crests greater than the wall thickness of the wave troughs in order to create a reliable contact surface on the one hand and to ensure a high degree of deformability on the other hand. However, the advantageous effects of the undulating structure 240 may also be effective to a certain extent if a wall thickness is provided that is almost identical for wave crests and wave troughs, as is indicated in FIG. 2C.

Furthermore, also in these embodiments, an upper side 2400 and a lower side 240U of the undulating structure 240 are designed such that the lower side 240U at the section 241A of the wave crest 241 has a maximum distance to the hose region 210 and the lower side 240U at the section 242A of the wave trough 242 has a minimum distance to the hose region 210. The lower side 240U and also the upper side 2400 thus have a serpentine shape in side view, as is also described above in connection with the milking shear insert 100.

In general, it should be noted that all design measures described in connection with the embodiments of FIGS. 1A to 1F may also be applied in the same way to the embodiments as described in the context of FIGS. 2A to 2C.

Thus, the present invention is based on the concept that the deformability of a teat cup liner in the region of the teat insertion opening may be improved by providing an undulating structure as an integral part of the teat cup liner. This provides a large contact surface for contact with the relevant teat area and improved adaptability to teats of different sizes may be achieved due to the bellows-like or serpentine course of the undulating structure along the circumferential direction of the opening, without increasing the risk of a teat cup falling off and at the same time causing adverse effects on the tissue of the teat. Furthermore, it is possible to manufacture the entire teat cup liner from a softer material mixture, such as a softer polymer mixture, without causing the conventionally associated disadvantages of a lower adhesive force.

1. Elastic teat cup liner for holding a teat, comprising
a hose region,
a top region adjoining in a longitudinal direction of the hose region, which is configured for attachment to a teat cup sleeve and is provided with a teat insertion opening, and
an annular region delimiting the teat insertion opening and acting as a teat contact surface in an operating position and having an undulating structure along a circumference of the teat insertion opening with an underside facing the hose region and an upper side facing away from the hose region, wherein the hose region, the top region and the annular region including the undulating structure are formed in the form of a single piece of material, and a wave crest of the undulating structure includes a wave crest section in a circumferential direction of the teat insertion opening, at which an underside of the wave crest section has a maximum distance from the hose region, and a wave trough of the undulating structure includes a wave trough section, at which an underside of the wave trough section has a minimum distance from the hose region which is different from the maximum distance,
wherein the wave crest section and the wave trough section have different wall thicknesses.

2. Elastic teat cup liner according to claim 1, wherein a radial extension of the undulating structure in the annular region starting from an edge of the teat insertion opening is numerically greater than a radius of the teat insertion opening.

3. Elastic teat cup liner according to claim 1, wherein the wave crest section has a greater wall thickness than the wave trough section.

4. Elastic teat cup liner according to claim 1, wherein at an edge of the teat insertion opening an extension length of the wave troughs is greater than an extension length of the wave crests.

5. Elastic teat cup liner according to claim 1, wherein an extension of the wave troughs in the circumferential direction remains substantially the same with increasing distance from the teat insertion opening.

6. Elastic teat cup liner according to claim 1, wherein at least three wave troughs are provided in the undulating structure.

7. Elastic teat cup liner according to claim 6, wherein six or more wave troughs are provided.

8. Elastic teat cup liner according to claim 1, wherein the annular region is inclined from an edge of the top region towards the teat insertion opening in a direction of the hose region.

9. Elastic teat cup liner according to claim 1, wherein the teat insertion opening is suitably dimensioned so as to enable insertion of a teat of a dairy animal.

10. Elastic teat cup liner according to 1, wherein the teat insertion opening is suitably dimensioned so as to enable insertion of a teat of a a sheep or a goat.

11. Elastic teat cup liner according to 1, wherein the teat insertion opening is suitably dimensioned so as to enable insertion of a teat of a cow or a buffalo.
